(19) United States
(12) Patent Application Publication
(10) Pub. No.: US 2010/0193514 A1
(43) Pub. Date: Aug. 5, 2010

(54) TANK FILLER NECK AND METHOD FOR PRODUCING A TANK FILLER NECK

(75) Inventor: Janos KERTESZ, Sulzbach (DE)

Correspondence Address: GREENBLUM & BERNSTEIN, P.L.C., 1950 ROLAND CLARKE PLACE, RESTON, VA, 20191, US

(73) Assignee: NORMA GERMANY GMBH, Maintal (DE)

(21) Appl. No.: 12/691,460

(22) Filed: Jan. 21, 2010

(30) Foreign Application Priority Data
Jan. 31, 2009 (DE) 20 2009 001 201.8

(51) Int. Cl. B60K 15/04; B28B 21/92

(52) U.S. Cl. 220/86.2; 83/13; 264/138; 264/239

(57) ABSTRACT

Tank filler neck and method for producing the tank filler neck. The tank filler neck includes a smooth-walled pipe and a flange molded onto the pipe that is arranged on at least one end of the pipe.

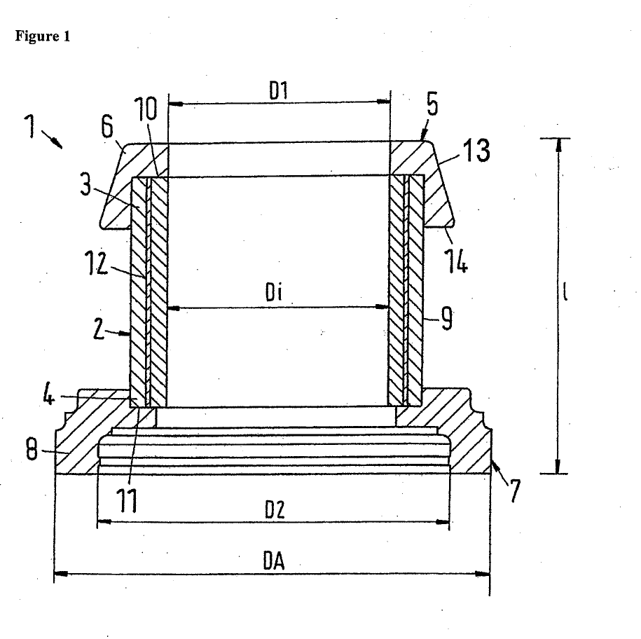

### CROSS-REFERENCE TO RELATED APPLICATIONS

The present application claims priority under 35 U.S.C. §119(a) of German Patent Application No. 20 2009 001 201.8 filed Jan. 31, 2009, the disclosure of which is expressly incorporated by reference herein in its entirety.

### BACKGROUND OF THE INVENTION

1. Field of the Invention

The invention relates to a tank filler neck with a pipe. A flange is arranged on at least one end of the pipe. Furthermore, the invention relates to a method for producing a tank filler neck of this type.

2. Discussion of Background Information

Tank filler necks are used, e.g., to connect a tank, such as, for example, a fuel tank of a motor vehicle, to a fuel line. The tank filler neck must thereby ensure a secure and tight connection between the fuel tank and the fuel line. Conventional tank filler necks are therefore provided with flanges at their ends in a one-piece manner, which flanges are used to connect to the tank or to the fuel line.

The one-piece production of the tank filler neck is generally carried out in an injection molding process. Adapted injection molds are necessary for different installation conditions, in particular when different lengths of the tank filler neck are required. Since injection molds are relatively expensive, this means either that the tank filler necks are not adapted in an optimum manner or that the tank filler necks cost a correspondingly high price.

### SUMMARY OF THE INVENTION

Embodiments of the invention provide a tank filler neck that can be produced in different lengths with low expenditure.

According to the embodiments, a tank filler neck of the type mentioned at the outset includes a smooth-walled pipe and a flange molded onto the pipe.

Since the pipe is embodied or formed in a smooth-walled manner, it is possible to cut the pipe in the desired length from a prefabricated pipe piece. In this way, storage is substantially simplified thereby. Since the flange is molded onto this finished pipe, it is not necessary to adapt an injection mold to a desired length of the tank filler neck. As a rule, the pipe and the flange are thereby produced from plastic. It is also possible thereby to use different materials, for example, different plastics, in order to obtain desired properties. By molding on the flange, a reliable and durable connection between the flange and the pipe is produced which has a high tightness. No further additional sealing elements are therefore necessary. The production effort and thus the production costs of the tank filler neck are thus kept low. An injection mold for the flange can be used for tank filler necks of different length, so that the unit cost is low.

In a particular embodiment, the flange can bear against a front face and a circumferential surface of the pipe. Thus, the end of the pipe is surrounded by the flange and protected from mechanical and other environmental influences. At the same time, the contact surface between the flange and the pipe is relatively large, so that a durable connection between the flange and the pipe is obtained. These connecting forces are intensified further by the fact that the front face and the circumferential surface of the pipe run virtually at right angles to one another.

Advantageously, the pipe has a barrier layer. The barrier layer is used to ensure the tank filler neck is low-emission. In particular, it prevents the diffusion of hydrocarbons, which are contained in most fuels. The barrier layer is formed, for example, of aluminum or a plastic.

Preferably, the front face is covered at least to the extent that the barrier layer is covered. The flange therefore does not serve only to connect the tank filler neck to another component, but also to protect the front face. Fuel, for example, is thus prevented from penetrating into the front face of the pipe, which in the worst case can lead to a destruction of the pipe. At the same time, of course, a high tightness is also obtained.

Preferably, a second flange is molded onto a second end of the pipe. This flange, just like the first flange, can bear against a front face and the circumferential surface of the pipe. It likewise serves to connect the tank filler neck to a component. The tank filler neck can thus be reliably attached with both of its ends.

Advantageously, an outside and/or an inside of the pipe is covered with a covering that is embodied or formed in one piece with at least one of the flanges. This covering serves to increase the mechanical strength of the tank filler neck and to improve the emission density of the tank filler neck. The covering can thereby be produced from the same material as the flanges, for example, of polyethylene (PE). If the covering covers the inside and the outside of the pipe, the pipe is essentially embedded in the covering and the flanges. An embodiment of this type can also be achieved with different pipe lengths with slight changes in the injection molds, since the shape is predetermined by the pipe. Thus, it is necessary only to provide corresponding intermediate pieces for the injection mold between the flanges. The covering itself can thereby be embodied or formed to be relatively thin, since the pipe has sufficient stability.

Preferably, one of the flanges is embodied or formed as an insert piece to be accommodated in a sleeve embodied or formed in a corresponding or complementary manner. In this manner, the insert piece ensures a relatively quick and secure connection.

In a particular embodiment, the insert part has a chamfered edge and a locking edge. The chamfered edge is used for easier engagement of a locking ring. In this way, the sleeve is engaged on the locking edge so that a secure connection is obtained which cannot be disconnected by itself.

Preferably, one of the flanges is embodied or formed as a welding flange. Welding, in particular plastic welding, is a type of connection that is often used between a tank and a tank filler neck. A secure and durable connection is produced thereby. The surface of the tank filler neck is enlarged by the welding flange, so that a better connection can also be obtained between the tank filler neck and the tank.

In other embodiments, an opening cross section of the flange on its side facing away from the pipe is greater than an inner diameter of the pipe. The flange can then accommodate an extension of the tank embodied or formed in a corresponding manner without an available flow cross section being restricted too far. Thus, for example, the inner diameter of an extension of this type can correspond to the inner diameter of the pipe, such that uniform flow conditions are obtained. At the same time, a relatively large surface is available for the welding between the tank filler neck and the tank, which leads to a secure connection.

Preferably, a maximum outer diameter of the tank filler neck is greater than its axial length. The tank filler neck itself therefore requires only relatively little construction space. This is advantageous in particular with the tight space available in a motor vehicle. The tank filler neck then is used essentially only to render possible a secure connection between a fuel line and a fuel tank.

According to the invention, the embodiments of the invention include a method for producing a tank filler neck in that the pipe is cut to length from a smooth-walled prefabricated pipe piece and the flange is molded onto one end of the pipe.

Thus, the tank filler neck can be produced in virtually any desired length. Further, the pipe is cut to length from a prefabricated pipe piece that is easy to store. The adjustment of the length of the tank filler neck is carried out solely through the selection of a pipe with suitable length. An adjustment of an injection mold is not necessary. Instead, tank filler necks in virtually any desired length can be produced with a single injection mold. The injection molding is made cost-effective, despite the relatively expensive injection mold. At the same time, a reliably tight and durable connection between the flange and the pipe is produced by molding the flange onto the pipe.

Preferably, both ends of the pipe are each provided with a flange. The flanges can be embodied or formed to be identical or to be different. Further, the flanges can be molded simultaneously or consecutively. Through the two flanges, a tank filler neck is obtained that can be used in a versatile manner and that can be connected well to other components.

Embodiments of the invention are directed to a tank filler neck. The tank filler neck includes a smooth-walled pipe and a flange molded onto the pipe that is arranged on at least one end of the pipe.

According to embodiments of the invention, the pipe can have a front face and a circumferential surface, and the flange may be structured and arranged to bear against the front face and the circumferential surface.

Further, the pipe can include a barrier layer, and the flange may be arranged to cover a front face of the pipe at least to an extent that the barrier layer is covered.

In accordance with other embodiments, a second flange can be molded onto a second end of the pipe. Moreover, a covering may be formed on at least one of an outside and an inside of the pipe. The covering may be formed in one piece with at least one of the flanges. One of the flanges can be structured and arranged as an insert piece. Further, the insert part can include a chamfered edge and a locking edge. Still further, one of the flanges can be structured and arranged as a welding flange. An opening cross section on a side of one of the flanges that faces away from the pipe is greater than an inner diameter of the pipe.

According to embodiments, a maximum outer diameter of the tank filler neck is greater than its axial length.

Embodiments of the invention are directed to a method for producing the above-noted tank filler neck. The method includes cutting the pipe to predetermined length from a smooth walled prefabricated pipe piece, and molding the flange onto one end of the pipe.

According to aspects of the embodiments, the method can include providing another flange on an other end of the pipe.

Embodiments of the invention are directed to a method for producing a tank filler neck. The method includes forming a flange on an end of a predetermined length of a smooth-walled pipe. The formed flange covers at least a portion of an end face of the end of the pipe.

In accordance with aspects of the embodiments, the method can include forming a second flange on an other end of the pipe, wherein the formed second flange covers the end face of the pipe. Moreover, a greatest diameter of the flanges is greater than an axial length of the pipe.

According to embodiments of the invention, the pipe can include a barrier layer arranged within the pipe, and the formed flange can cover a portion of the end pipe that includes the barrier layer.

Further, one of the flanges may include a chamfered edge and a locking edge.

In accordance with still yet other embodiments of the present invention, one of the flanges can be structured and arranged as a welding flange. An opening cross section on a side of the one flange that faces away from the pipe may be greater than an inner diameter of the pipe.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted drawing by way of non-limiting example of an exemplary embodiment of the present invention, and wherein:

The FIGURE illustrates an exemplary embodiment of a tank filler neck in accordance with embodiments of the invention.

### DETAILED DESCRIPTION OF THE EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied or formed in practice.

The only FIGURE shows a tank filler neck 1, which includes a pipe 2 with a first end 3 and a second end 4. A first flange 5, arranged on first end 3, can be embodied or formed as an insert part 6. Further, first flange 5 can be molded onto pipe 2.

A second flange 7, arranged on second end 4, can be embodied or formed as a welding flange 8.

Flanges 5 and 7 are connected to pipe 2 in such a manner that they bear against a circumferential surface 9 of pipe 2 and over respectively one front face 10 and 11 of pipe 2. First flange 5 completely covers front face 10 of pipe 2, while second flange 7 covers front face 11 only to an extent that a barrier layer 12, which is arranged inside pipe 2, is covered. However, it is also conceivable for flange 7 to completely cover front face 11.

Barrier layer 12 runs parallel to circumferential surface 9 of pipe 2, in order to prevent hydrocarbons from escaping through the pipe wall.

First flange 5 has an opening cross section D1 that corresponds to an inner diameter Di of pipe 2. In this manner, when a fuel flows through, there is therefore virtually no risk of swirling.

An opening cross section D2 of second flange 7, however, is greater than inner diameter Di of pipe 2. An extension of a fuel tank can thereby be accommodated in flange 7 without a flow cross section being unnecessarily constricted. Through the accommodation of an extension of this type, a large surface is then available for welding between tank filler neck 1 and a fuel tank so that a reliably tight and durable connection can be obtained.

Second flange 7 has an outer diameter DA that is greater than an axial length L of tank filler neck 1. Thus, tank filler neck 1 is embodied or formed in a relatively compact manner.

The first flange 5 has a chamfered edge 13 and a locking edge 14. Chamfered edge 13 makes it easier to insert flange 5 into a receptacle. Chamfered edge 13 additionally makes it easier to apply a locking ring (not shown), which can engage behind locking edge 14 to produce a positive connection between tank filler neck 1 and a receptacle that is, e.g., part of a fuel line.

Through the production of tank filler neck 1 by three components, i.e., pipe 2, first flange 5, and second flange 7, only low expenditure is necessary for a variable production of tank filler neck 1. Tank filler neck 1 can be adapted to different installation conditions through a simple replacement of individual components. Tank filler neck 1 can easily be adapted to different installation conditions in particular through the selection of the length of pipe 2, which does not necessitate any changes at all to the further components necessary for the production of tank filler neck 1. Pipe 2 can be ordered as a bulk commodity so that it is easy to store and is relatively cost-effective. A low emission tank filler neck 1 is nevertheless obtained by molding flanges 5 and 7 on pipe 2. In this respect no disadvantages are to be anticipated compared to the one-piece tank filler necks hitherto used. However, the tank filler neck according to the invention renders possible a cost-effective and simple production.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A tank filler neck comprising:
a smooth-walled pipe;
a flange molded onto the pipe that is arranged on at least one end of the pipe.

2. The tank filler neck in accordance with claim 1, wherein the pipe has a front face and a circumferential surface, and the flange is structured and arranged to bear against the front face and the circumferential surface.

3. The tank filler neck in accordance with claim 1, wherein the pipe comprises a barrier layer.

4. The tank filler neck in accordance with claim 3, wherein the flange is arranged to cover a front face of the pipe at least to an extent that the barrier layer is covered.

5. The tank filler neck in accordance with claim 1, further comprising a second flange molded onto a second end of the pipe.

6. The tank filler neck in accordance with claim 5, further comprising a covering on at least one of an outside and an inside of the pipe, wherein the covering is formed in one piece with at least one of the flanges.

7. The tank filler neck in accordance with claim 5, wherein one of the flanges is structured and arranged as an insert piece.

8. The tank filler neck in accordance with claim 7, wherein the insert part comprises a chamfered edge and a locking edge.

9. The tank filler neck in accordance with claim 5, wherein one of the flanges is structured and arranged as a welding flange.

10. The tank filler neck in accordance with claim 9, wherein an opening cross section on a side of one of the flanges that faces away from the pipe is greater than an inner diameter of the pipe.

11. The tank filler neck in accordance with claim 1, wherein a maximum outer diameter of the tank filler neck is greater than its axial length.

12. A method for producing the tank filler neck in accordance with claim 1, comprising:
cutting the pipe to predetermined length from a smooth-walled prefabricated pipe piece; and
molding the flange onto one end of the pipe.

13. The method in accordance with claim 12, further comprising providing another flange on an other end of the pipe.

14. A method for producing a tank filler neck, comprising:
forming a flange on an end of a predetermined length of a smooth-walled pipe,
wherein the formed flange covers at least a portion of an end face of the end of the pipe.

15. The method in accordance with claim 14, further comprising forming a second flange on an other end of the pipe, wherein the formed second flange covers the end face of the pipe.

16. The method in accordance with claim 15, wherein a greatest diameter of the flanges is greater than an axial length of the pipe.

17. The method in accordance with claim 14, wherein the pipe includes a barrier layer arranged within the pipe, and the formed flange covers a portion of the end pipe that includes the barrier layer.

18. The method in accordance with claim 14, wherein one of the flanges comprises a chamfered edge and a locking edge.

19. The method in accordance with claim 14, wherein one of the flanges is structured and arranged as a welding flange.

20. The method in accordance with claim 19, wherein an opening cross section on a side of the one flange that faces away from the pipe is greater than an inner diameter of the pipe.
